(19) United States
(12) Patent Application Publication
(10) Pub. No.: US 2002/0071625 A1
(43) Pub. Date: Jun. 13, 2002

(54) Wave-guided miniature spectrophotometer transducer

(76) Inventors: Dwight Urban Bartholomew, Dallas, TX (US); Diane L. Arbuthnot, Plano, TX (US)

Correspondence Address: Christopher L. Maginnis, Texas Instruments Incorporated, P.O. Box 655474, M.S. 3999, Dallas, TX, 75265, US

(21) Appl. No.: 09/732,248

(22) Filed: Dec. 7, 2000

Related U.S. Application Data
(60) Provisional application No. 60/174,063, filed on Dec. 30, 1999.

(51) Int. Cl. G02B 6/00

(52) U.S. Cl. 385/12

(57) ABSTRACT

A spectrophotometer transducer is disclosed that includes a chemically sensitive wave-guiding thin film and a light detector coupled to the wave-guiding thin film. The light detector is adapted to respond to light transmitted through the wave-guiding thin film. Vapors reacting with the wave-guiding thin film reflect light transmitted through the wave-guiding thin film. The light detector recognizes changes in the transmitted light to identify the vapor that reacted with the wave-guiding thin film.

### CROSS-REFERENCE TO RELATED APPLICATIONS

The following applications contain subject matter related to the present application and are assigned to the assignee of the present application: co-filed applications with Ser. Nos_______ and_______.

### GOVERNMENT CONTRACT

This invention was made with Government support under Defense Applied Research Projects Agency contract number DABT63-97-C-0018. The Government has certain rights in this invention.

### BACKGROUND OF THE INVENTION

Without limiting the scope of the invention, its background is described in connection with land mine detection, as an example.

Spectrophotometers analyze the absorption of light through a material to determine the composition of the material. They may be used to measure many different properties of the material. One of the properties that may be measured is the presence of various chemicals within the structure of the material. This technology may be adapted to detect the presence of explosives within an area.

Anti-personnel mines, commonly called land mines, cause severe injuries and casualties to thousands of civilians and military troops around the world each year. There are over 120 million land mines currently deployed in over 60 countries around the world. Each year, over 2 million new land mines are laid, while only about 100,000 mines are cleared.

These mines are typically deployed randomly within a strategic area and may be buried or camouflaged so they are invisible to a casual observer. Mines may instantly and indiscriminately claim unsuspecting victims who step or drive on the mine's triggering mechanism. The clandestine and indiscriminate nature of land mines make them a particularly dangerous weapon for anyone in close proximity to the mine.

Mines contain an explosive, which rapidly accelerates shrapnel or other projectiles when activated. Many mines contain trinitrotolulene (TNT), which is a common explosive compound. TNT and other explosives are polynitroaromatic compounds that emit a vapor. This emitted vapor may be useful to detect mines and other explosives.

Current detection methods range from high-tech electronic (ground penetrating radar, infra-red, magnetic resonance imaging) to biological detection schemes (dog sniffers and insects or bacteria) to simple brute force detonation methods (flails, rollers and plows) and the use of hand-held mechanical prodders. Most of these methods are very slow and/or expensive and suffer from a high false alarm rate. Mines usually do not possess self-destroying mechanisms and due to their long active time jeopardize the lives of millions of people. Furthermore, mines are difficult to find with commercial metal detectors, because their metal content is very low and in some cases even zero.

### SUMMARY OF THE INVENTION

Therefore, a system that detects mines having little or no metallic content is now needed; providing enhanced design performance and accuracy while overcoming the aforementioned limitations of conventional methods.

Generally, and in one form of the invention, a spectrophotometer transducer includes a chemically sensitive wave-guiding thin film coupled to a light detector and adapted to respond to light transmitted through the wave-guiding thin film. Vapors reacting with the wave-guiding thin film alter the transmission of light through the wave-guiding thin film. The light detector recognizes changes in the transmitted light to identify the vapor that reacted with the wave-guiding thin film.

In one embodiment of the present invention, the spectrophotometer transducer has a wave-guiding thin film that is self-supporting.

In another embodiment of the present invention, the wave-guiding thin film has a reflective region to improve light transmission.

In yet another embodiment of the present invention, the spectrophotometer transducer has a light source to direct light through the wave-guiding thin film.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 is a schematic of a vapor detector;

FIG. 2 is a schematic of a vapor detector having a focused light source;

FIG. 3 is a schematic of a multiple vapor detector;

FIG. 3a is a schematic of a multiple vapor detector;

FIG. 4 is a schematic of a radiation detector; and

FIG. 5 is an illustrative embodiment of a vapor detector being used in a mine field.

### DETAILED DESCRIPTION OF THE INVENTION

While the making and using of various embodiments of the present invention are discussed in detail below, it should be appreciated that the present invention provides many applicable inventive concepts that may be embodied in a wide variety of specific contexts. The specific embodiments discussed herein are merely illustrative of specific ways to make and use the invention and do not delimit the scope of the invention.

For purposes of illustration, a vapor detector that uses a polymer waveguide sensitive to polynitroaromatic compounds is provided. The principles and applications of the present invention are not limited only to detecting explosives; being applicable to detection of radiation, a variety of vapors from many different substances or both, or contaminants in liquids or solutions.

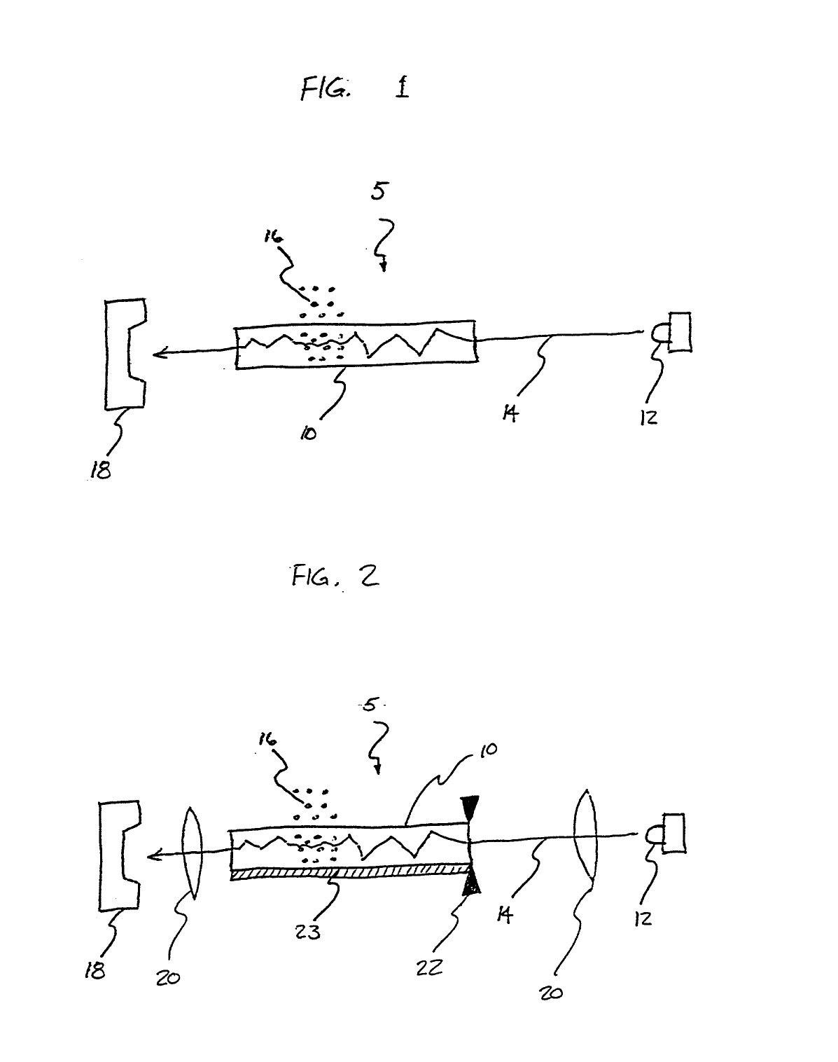

Referring now to FIG. 1, a schematic representative of a vapor detector 5 is shown. A waveguide 10 may be formed from a variety of polymer compounds, such as polyvinylchloride (PVC), for example, that are suitable for producing an optically clear structure. The waveguide 10 is impregnated or infused with a chemical, Jeffamine T-403 (developed by TEXACO) for example, that reacts with vapor from the compound to be detected.

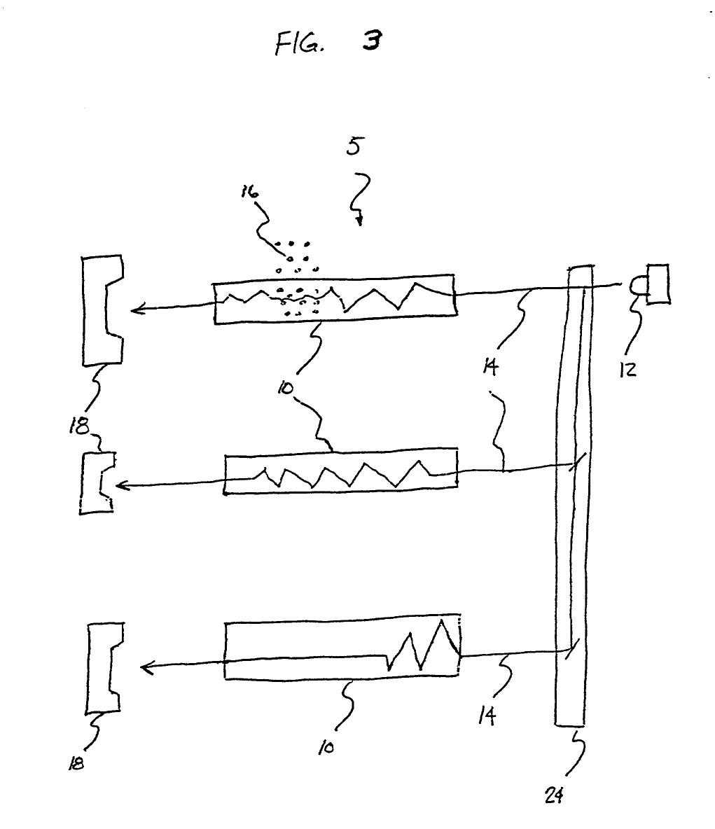

In this specific example, Jeffamine also acts as a plasticizer for the PVC compound. Inherent rigidity in the PVC compound allows the waveguide 10 to be self-supporting. A self-supporting waveguide 10 simplifies production and reduces associated costs of the device. The waveguide 10, alternatively, may be deposited on a substrate (shown in FIG. 2).

For example, in operation, the vapor detector 5 may be used as follows. Many land mines contain TNT, which is a polynitroaromatic compound. Jeffamine T-403 reacts with TNT vapor thereby altering the light absorbent properties of the waveguide 10. Other chemicals may be mixed with the polymer of the waveguide 10 to allow the vapor detector 5 to detect other compounds. The vapor detector 5 may also incorporate several waveguides 10 to detect multiple compounds at a single location.

A light source 12 may be used to emit light 14 into waveguide 10. The light source 12 may be an incandescent lamp, an LED, a laser or any other light producing device known in the art. Vapor 16 that has reacted with chemicals within waveguide 10 absorbs some of the light 14. The remainder of light 14 passes through waveguide 10 into a light detector 18.

Light detector 18 analyzes the characteristics of the light 14 that is transmitted through the waveguide 10, which has been exposed to vapor 16, to identify the compound that emitted vapor 16. Light detector 18 may be a semi-conductor photo-detector, a photo-multiplier tube, a bolometer or other heat or light-sensitive detector known in the art.

Now referring to FIG. 2, an alternative embodiment of the invention is illustrated. Light 14 from light source 12 may be focused with one or more lenses 20 to obtain a more accurate transmission of light 14 through waveguide 10. A light block 22 may be used to direct light 14 into waveguide 10 and eliminate any stray light from sources other than the intended light source 12. A reflective region 23 may be included on the waveguide 10 to further enhance the intensity of transmitted light 14. The reflective region 23 may be made from polished metal or any other suitable reflective material.

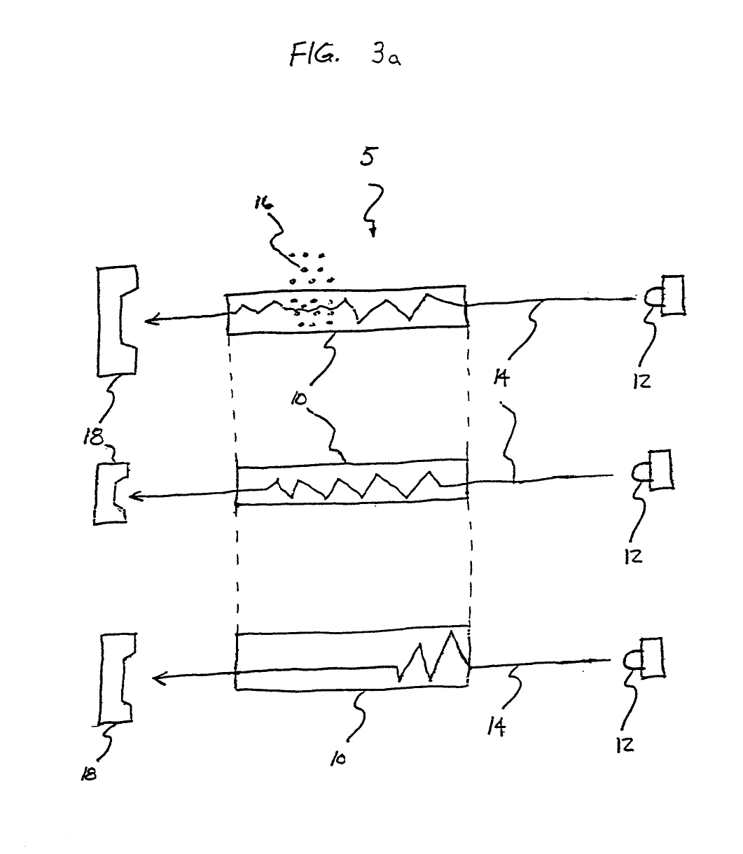

Another embodiment of the invention is illustrated in FIG. 3. A beam splitter 24 may be used to create multiple beams of light 14 from a single light source 12. These multiple beams of light 14 may be directed into multiple different waveguides 10 by lenses 20 and light blocks 22. The light 14 is transmitted through the waveguides 10 into multiple light detectors 18. Each waveguide 10 may be compounded with a different chemical to detect a unique compound. A vapor detector 5 with multiple, individually configured waveguides 10 could detect the presence of several different compounds located in a single area.

Another embodiment of the invention is illustrated in FIG. 3a. Multiple beams of light 14 may be directed into multiple different waveguides 10 by multiple light sources 12. Multiple beams of light 14 are transmitted through the waveguides 10 into multiple light detectors 18. Each waveguide 10 may be compounded with a different chemical to detect a unique compound. Each light source 12 may emit a different wavelength of light, which is also designed to detect a unique compound. Alternatively, as indicated by the dotted lines, one embodiment of the invention may have a single waveguide 10.

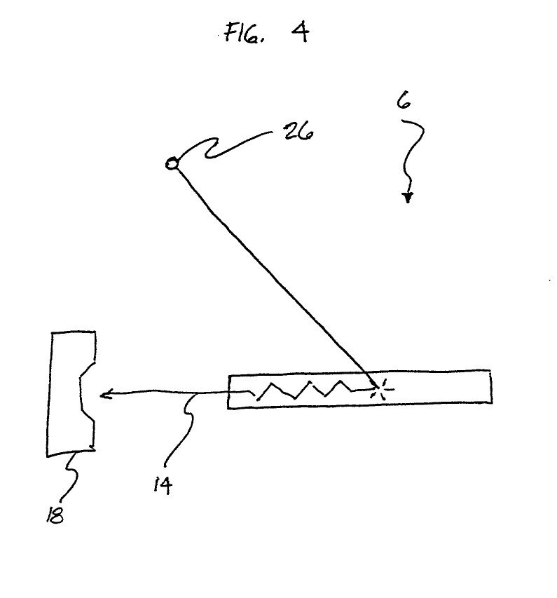

Now referring to FIG. 4, a radiation detector 6 may contain waveguide 10, which may contain a chemical that emits light when exposed to radiation. Radioactive particle 26 impinges waveguide 10 and causes a reaction with a scintillating chemical in the waveguide 10 that produces light 14. The light 14 is transmitted through waveguide 10 and into light detector 18. Light detector 18 analyzes the characteristics of the light 14 that is transmitted through the waveguide 10, and signals the presence of radiation within the area.

The source radiation must be converted into visible light prior to its detection by light detector 18. This is accomplished by a scintillation chemical compounded in the waveguide 10. A scintillation chemical is a material that emits optical photons in response to ionizing radiation. Optical photons are photons with energies corresponding to wavelengths between 3,000 and 8,000 angstroms. Thus, the scintillation compound converts source radiation energy from radioactive particle 26 into visible light energy, which may then be detected by the light detector 18.

Examples of scintillation layer material for this application may include: GdO₂ S₂, Csl, Csl:TI, BaSO₄, MgSO₄, SrSO₄, Na₂ SO₄CaSO4, BeO, LiF, CaF₂, etc. A more inclusive list of such materials is presented in U.S. Pat. No. 5,418,377, which is incorporated herein by reference. Commercial scintillation layers may contain one or more of these materials.

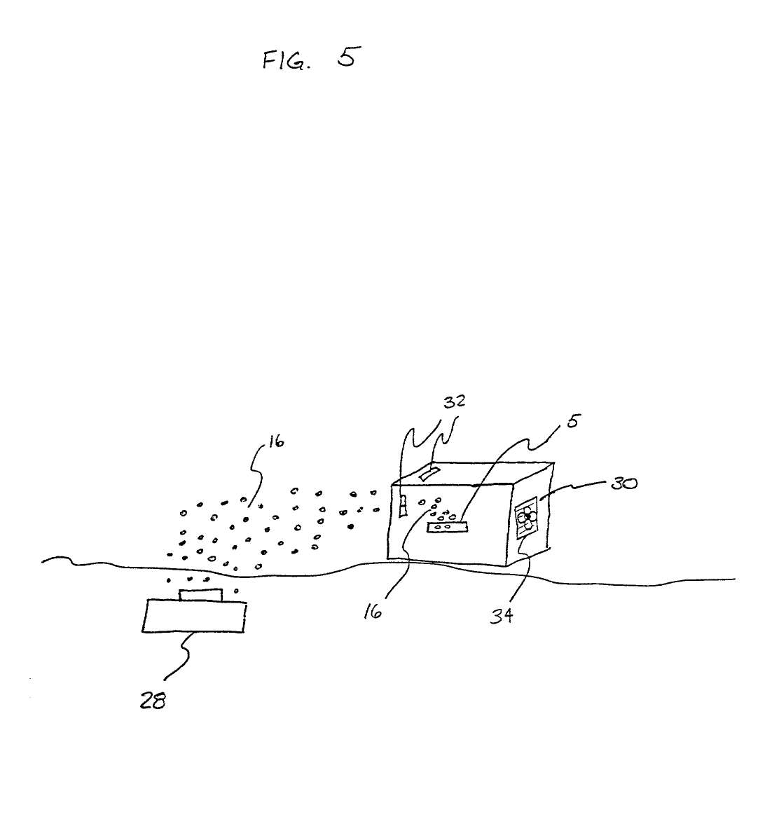

Referring now to FIG. 5, the vapor detector 5 is shown in use in an area that contains one or more land mines 28. The vapor detector 5 is enclosed in a robust housing 30, which protects the vapor detector 5 from hostile environmental conditions such as rain, snow, sunlight and even wild animals. The housing 30 may be designed to shockproof the vapor detector 5 for deployment by airplane or parachute. The housing 30 may also use a self-righting design that ensures proper vapor detector 5 orientation if the vapor detector 5 is deployed by aircraft.

Land mine 28 contains an explosive that emits vapor 16, which emanates into vents 32 in the housing 30 and exposes vapor detector 5. Vapor 16 reacts with chemicals within waveguide 10. Light 14 transmitted through waveguide 10 is partially absorbed by the reactants and is detected by light detector 18. Light detector 18 signals the presence of land mine 28 in the area.

The housing 30 may also be fitted with a fan 34. The fan 34 operates to increase air flow from the surrounding area across the waveguide 10. The fan 34 decreases the time necessary for the vapor detector 5 to detect vapor 16 in an area. The fan 34 also increases the sensitivity and range of the vapor detector 5 by exposing the waveguide 10 to a larger volume of air and vapor 16 within the area.

The housing 30 also contains a power supply for the circuitry of the vapor detector 5 and the fan 34. The power supply may be a battery, solar power or a combination of battery and solar power.

While this invention has been described in reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A spectrophotometer transducer comprising:
a chemically sensitive wave-guiding thin film; and
a light detector, coupled to said wave-guiding thin film, and adapted to respond to light transmitted through said wave-guiding thin film.

2. The spectrophotometer transducer of claim 1 wherein said wave-guiding thin film is self-supporting.

3. The spectrophotometer transducer of claim 1 further comprising a light focusing element to focus light from said wave-guiding thin film into said light detector.

4. The spectrophotometer transducer of claim 1 further comprising a light wavelength filter element to filter said transmitted light.

5. The spectrophotometer transducer of claim 1 wherein said wave-guiding thin film has a reflective region.

6. The spectrophotometer transducer of claim 1 wherein said wave-guiding thin film contains Jeffamine.

7. The spectrophotometer transducer of claim 1 further comprising a light source to direct light through said wave-guiding thin film.

8. A wave-guided spectrophotometer transducer comprising:
a chemically sensitive waveguide; and
a light detector, coupled to said waveguide, and adapted to generate a signal corresponding to light transmitted through said waveguide.

9. The transducer of claim 8 wherein said waveguide is self-supporting.

10. The transducer of claim 8 wherein said transducer includes a light focusing element to focus light from said waveguide into said light detector.

11. The transducer of claim 8 further comprising a light wavelength filter element to filter said transmitted light.

12. The transducer of claim 8 wherein said waveguide has a reflective region.

13. The transducer of claim 8 wherein said waveguide contains Jeffamine.

14. The transducer of claim 8 further comprising a light source to direct light through said waveguide.

15. The transducer of claim 8 wherein said waveguide reacts to radiation.

16. A method of producing a vapor detector, said method comprising the steps of:
providing a chemically sensitive waveguide; and
coupling said waveguide to a light detector.

17. The method of claim 16 further comprising the step of fabricating said waveguide to be self-supporting.

18. The method of claim 16 further comprising the step of providing a light focusing element.

19. The method of claim 16 further comprising the step of providing a light wavelength filter element.

20. The method of claim 16 wherein the step of providing a waveguide further comprises providing a reflective region coupled to said waveguide.

21. The method of claim 20 wherein the step of providing a waveguide further comprises providing Jeffamine in said waveguide.
